(19) United States
(12) Patent Application Publication
(10) Pub. No.: US 2004/0212182 A1
(43) Pub. Date: Oct. 28, 2004

(54) INFLATOR WITH MOVABLE PRESSURE VESSEL

(76) Inventor: Jb Canterberry, Apollo Beach, FL (US)

Correspondence Address: KEY SAFETY SYSTEMS, INC., PATENT DEPARTMENT, 5300 ALLEN K BREED HIGHWAY, LAKELAND, FL, 33811-1130, US

(21) Appl. No.: 10/419,905

(22) Filed: Apr. 22, 2003

(51) Int. Cl. B60R 21/26

(52) U.S. Cl. 280/737

(57) ABSTRACT

The compressed gas inflator has a movable pressure vessel. The pressure vessel is biased away from an impinger by a spring. At the occurrence of a car crash, the igniter in the compressed gas inflator is fired. The burning of the pyrotechnic material in the igniter produces sufficient output energy to overcome the biasing force of the spring and propel the pressure vessel into the impinger. The impinger ruptures a hole in the burst disk of the pressure vessel and the gas in the pressure vessel is able to quickly exit the pressure vessel.

### FIELD OF THE INVENTION

This invention relates to a gas inflator that releases gas to inflate an airbag and particularly relates to an inflator having a pressure vessel that opens when the pressure vessel moves into contact with a stationary impinger.

### BACKGROUND OF THE INVENTION

Inflatable restraints, which are commonly known as airbags are installed in vehicles to reduce injury to vehicle occupants during a car collision. Within a fraction of a second, airbags are inflated to prevent the vehicle occupant from impacting the hard surfaces of the interior compartment such as the steering wheel or the instrument panel. On the other hand, the airbag slows the vehicle occupant deceleration by absorbing kinetic energy of the vehicle occupant in a controlled fashion. The airbag absorbs kinetic energy of the vehicle occupant by forcing inflation gas out of the airbag. Accordingly, the vehicle occupant experiences lower deceleration forces in a vehicle crash when the vehicle occupant interacts with a deployed airbag than with steering wheel or instrument panel.

The airbag is filled by inflation gas that is supplied by an inflator. In order for the airbag to be fully deployed before the vehicle occupant interacts with the airbag to afford maximum protection to the vehicle occupant, the inflator needs to provide inflation gas at an extremely fast rate. One well-known inflator type in the art is a compressed gas inflator or a stored gas inflator. The compressed gas inflator has a pressure vessel that is filled with high-pressure, compressed gas. The compressed gas inflator has a burst disk, which hermetically seals the pressure vessel to prevent gas from leaking out of the pressure vessel. In the event of a car crash, the burst disk is ruptured, and the gas quickly exits the inflator and flows into a folded airbag.

The burst disk in compressed gas inflators are opened by a variety of methods. For example, a burst disk may be ruptured by a projectile or by a shockwave generated by the ignition of a pyrotechnic material. Another method of opening the burst disk is to use a rupture or dislodge a support member. In this method, the support member supports a burst disk to prevent the stored gas from failing the burst disk. During a car crash, the support member is ruptured or dislodged, and consequently, the forces from the gas on the burst disk are sufficient to burst the burst disk.

All of the aforementioned approaches to opening a compressed gas inflator have a common feature, which is that the pressure vessel remains stationary during the opening process of the burst disk. Because of the importance of compressed gas inflators in the safety restraint industry, there is a desire to develop other suitable approaches to opening the compressed gas inflator that are reliable and cost effective.

### SUMMARY OF THE INVENTION

The compressed gas inflator in accordance with the present invention has a reaction can, a pressure vessel, and an electrical igniter. The pressure vessel and the electrical igniter are mounted inside the reaction can. A spring force associated with a spring prevents the pressure vessel from contacting an impinger. During a car crash, the igniter is fired causing the pressure vessel to be propelled into an impinger thereby opening the pressure vessel. The gas is then able to flow out of the inflator.

Another aspect of the present invention is a compressed gas inflator having the nozzels of two pressure vessels facing away from one another.

### BRIEF DESCRIPTION OF THE DRAWINGS

FIG. 1 shows an exploded view of the inflator in accordance with the present invention.

FIG. 2 shows a cross section of the compressed gas inflator.

FIG. 3 shows the cross section of an alternate embodiment of the present invention.

### DETAILED DESCRIPTION OF THE INVENTION

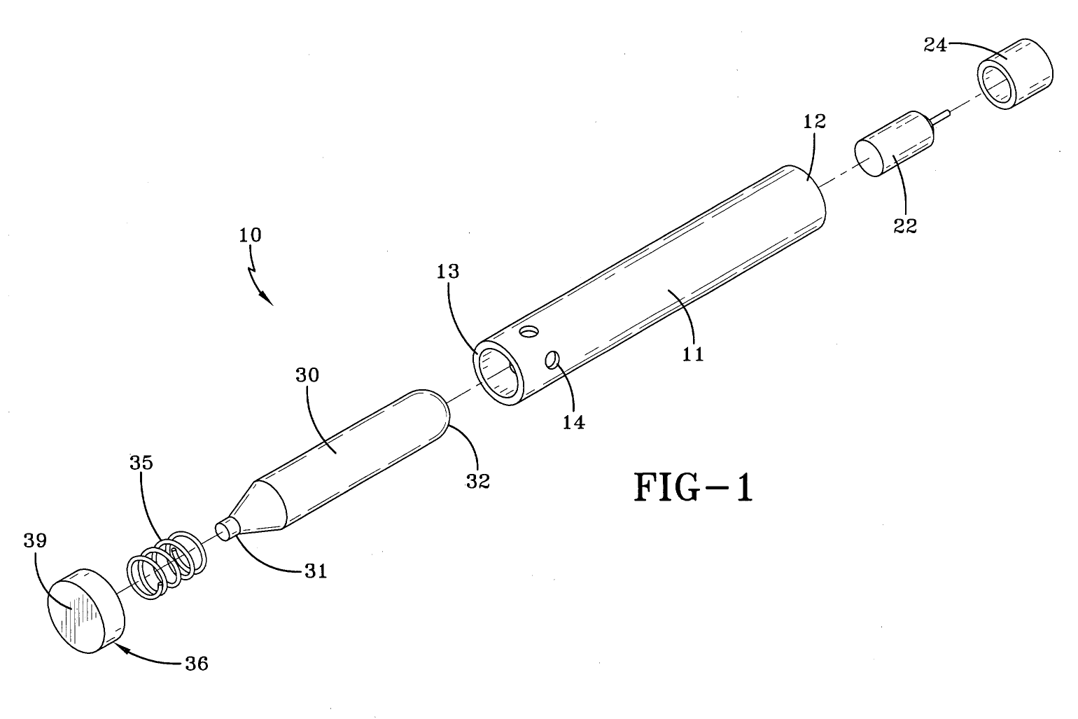

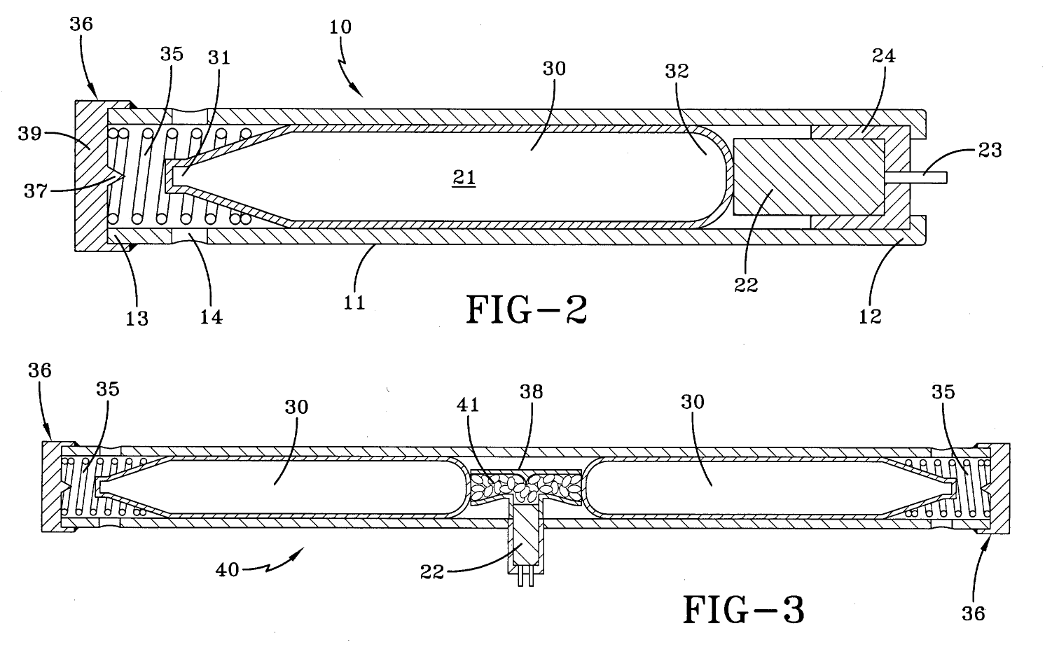

The compressed gas inflator 10 in accordance with the present invention is shown in FIGS. 1 and 2. As seen in FIG. 1, the reaction can 11 has a generally cylindrical shape and is large enough to receive the entire pressure vessel 30. The reaction can 11 may also have the shape of a rectangular shape or any other suitable geometric shape. The reaction can 11 has a plurality of exit ports 14 around the circumference thereof for directing inflation gas into the folded airbag. The exit ports 14 are arranged around the circumference of the reaction can 11 in a manner that creates a thrust neutral gas flow. The reaction can 11 is made from a metallic material such as low carbon steel, aluminum, and the like. Since the reaction can 11 is exposed to high amounts of force during the firing of the inflator, the reaction has the requisite strength not to rupture or explode during the rapid flow of inflation gas out of the inflator.

Attached to the first end 12 of the reaction can 11 is an endcap 24 having the igniter 22. FIG. 2 shows the reaction can 11 fixedly attached to the endcap 24 by crimping means, but other attachment means may be employed such as welding. The igniter 22 is attached to the endcap via an interference fit, but the igniter 22 may be attached via other suitable means such as gluing, crimping, welding, or threads. The igniter 22 is in electrical communication with an electronic control unit. The electronic control unit is an electronic device that receives signals from vehicle crash sensors and possibly from vehicle occupant sensors. The vehicle sensors detect vehicle deceleration while the vehicle occupant sensors senses vehicle occupant size and position. The electronic control unit utilizes deployment algorithms to determine if one or more safety devices should be actuated. If the electronic control unit determines that an airbag needs to be deployed, than the electronic control unit sends an activating signal to the igniter 22 of the compressed gas inflator 10. The electrical current flows along one pin 23 to an ignition resistor embedded in one or more layers of pyrotechnic ignition material. As the current passes along the resistor, the resistor generates heat, which ignites the ignition material. An example of a suitable ignition material for the present invention is zirconium potassium perchlorate, but one skilled in the art appreciates that other ignition materials may be used in the present invention.

A spacer (not shown) may be employed in the present invention to maintain a predetermined minimum distance between the igniter 22 and the bottom 32 of the pressure vessel 30. The spacer is disposed between the igniter 22 and the pressure vessel 30, and the spacer has a diameter that is approximately equal to the largest diameter of the pressure vessel 30.

The pressure vessel 30 is a metallic container for holding pressurized gas 21. Some suitable gases are the noble gases, carbon dioxide, nitrogen gas, and the like. The pressure vessel 30 wall has the attribute of being non-gas permeable so that the gas 21 does not leak out of the pressure vessel 30. Some suitable materials for the pressure vessel 30 are aluminum, steel, low carbon steel, however, one skilled in the art appreciates that other materials may be used so long as structural integrity is maintained when the pressure vessel 30 is filled with high pressure gas. At one end of the pressure vessel 30 is a nozzle 31 containing a burst disk (not shown). The burst disk is sealed to the pressure vessel 30 by welding or other suitable technique to prevent gas 21 from escaping through the nozzle 31 of the pressure vessel 30. The burst disk may either be pre-formed or pre-bulged before attachment to the pressure vessel 30 or the burst disk may bulge in a direction away from the pressure vessel 30 after the pressure vessel 30 is filled with gas 21.

The compressed gas inflator 10 also contains a spring 35 and an impinger 36. The spring 35 is situated between the impinger 36 and the pressure vessel 30, and the spring 35 biases the pressure vessel 30 away from the impinger 36. Preferably, the spring 35 has enough biasing force to push the bottom 32 of the inflator against the igniter 22. The impinger 36 has a sharp portion 37 extending from the center of the base 39. The sharp portion 37 faces the nozzle 31 of the pressure vessel 30. The spring 35 prevents the sharp portion 37 of the impinger 36 from contacting the burst disk of the pressure vessel 30. However, when the compressed gas inflator 10 is actuated, the biasing force is overcome and the impinger 36 pierces the burst disk. The operation of the compressed gas inflator 10 will be discussed later. The base 39 may be welded, crimped or attached to the second end 13 of the reaction can 11 by threads.

Upon receipt of an electrical signal from the electronic control unit, the electrical igniter 22 is actuated. The igniter resistor of the igniter 22 generates sufficient heat to ignite the ignition material. The burning of the ignition material produce hot gases and a shockwave, and collectively the hot gases and shockwave apply a force to the bottom 32 of the pressure vessel 30. The force from the burning of the ignition material is greater than the biasing force of the spring 35 on the pressure vessel 30, and hence the pressure vessel 30 is forcefully driven in the direction toward the impinger 36. The pressure vessel 30 will collide with the impinger 36 whereby the impinger 36 will rupture the burst disk. Very shortly after the burst disk is ruptured, the pressure vessel 30 will be pushed away from the impinger 36 because of the biasing force from the spring 35 and the thrust on the pressure vessel 30 caused by the gas 21 exiting the pressure vessel 30. Consequently, the gas 21 rapidly flows through the nozzle 31 of the pressure vessel 30 into the reaction can 11, and then out of the reaction can 11 by way of the exit ports 14.

FIGS. 3 shows a double pressure vessel inflator 40 having two impingers. The pressure vessels 30 are filled with gas 21 and the nozzles of the pressure vessels face in opposite directions. Similar to the embodiment in FIGS. 1 and 2, the double pressure vessel inflator 40 has an igniter 22. Connected to the igniter 22 is a splitter 38 that contains an enhancer 41. The enhancer 41 is a pyrotechnic material that is utilized to augment the output energy of the igniter 22, which increases the force applied to the bottom of the pressure vessels as well as heat the gas exiting the pressure vessel. The embodiment shown in FIGS. 1 and 2 may also utilize an enhancer. The splitter 38 channels hot combustion products toward the bottom 32 of each of the two pressure vessels. The hot gases and the shockwave collectively have sufficient energy to overcome the biasing force of the springs and drive the inflators toward their respective impingers 36. The collision of the impingers with the burst disks of the pressure vessels 30 results in the burst disks being ruptured. Subsequently, the gas 21 flows from the pressure vessels into the reaction can 11 and then exits the reaction can 11 via exit ports 14.

The preferred embodiments have been described herein-above. It will be apparent to those skilled in the art that the above methods may incorporate changes and modifications without departing from the general scope of this invention. It is intended to include all such modifications and alterations in so far as they come within the scope of the appended claims or the equivalents thereof.

I claim:

1. An inflator comprising:
a reaction can having a plurality of exit ports around the circumference thereof;
an igniter installed on a first end of the reaction can, the igniter is in communication with an electronic control unit;
a pressure vessel for storing gas, the pressure vessel has a burst disk for blocking the stored gas from exiting a nozzle of the pressure vessel; and
an impinger having a sharp portion extending from a base, the base is connectd the second end of the reaction can, whereby the firing of the igniter causes the pressure vessel to propel into the impinger causing the burst disk to be punctured.
